(19) United States
(12) Patent Application Publication
(10) Pub. No.: US 2008/0087872 A1
(43) Pub. Date: Apr. 17, 2008

(54) Detachable secure pole

(76) Inventors: Roland O. Young, Grand Forks, ND (US); Larry P. Young, Grand Forks, ND (US)

Correspondence Address: ROBERT E. KLEVE, 1103-24TH AVE S., GRAND FORKS, ND, 58201, US

(21) Appl. No.: 11/546,065

(22) Filed: Oct. 11, 2006

(51) Int. Cl. B60P 1/14

(52) U.S. Cl. 254/4 R

(57) ABSTRACT

The invention comprises a lift device having base with a detachable upright tubular pole, a lifting apparatus adjustably mounted on said pole for lifting various objects upward and downward on said pole, said base having a upright post to be received in said tubular pole with expandable means in said post to expand to engage the inner surfaces of said pole to achieve a rigid connection between said post of said base and said pole to enable said base and said pole to be rigidly secure when operating said lifting apparatus on said pole.

This invention relates to cabinet lifts, more particularly improvements in cabinet lifts for quickly and easily disassembling them when not in use and to provide a more secure connection and keep the main post of the lift more stable.

It is another object of the invention to make the main post of the cabinet lift easier to assemble and disassemble to the base.

It is an object of the invention to provide a novel cabinet lift which provides improved performance and is easier to manufacture. Further objects and advantages of the invention will become apparent of the description proceeds and when taken in conjunction with the accompanying drawings where in:

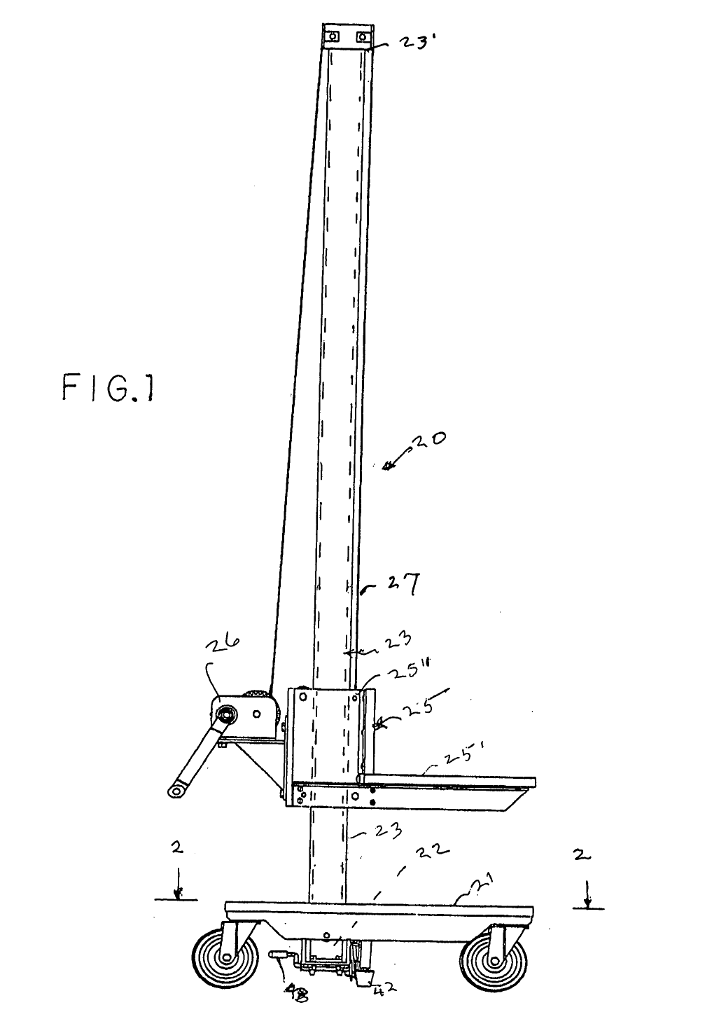

FIG. 1 is a side elevational view of the cabinet lift.

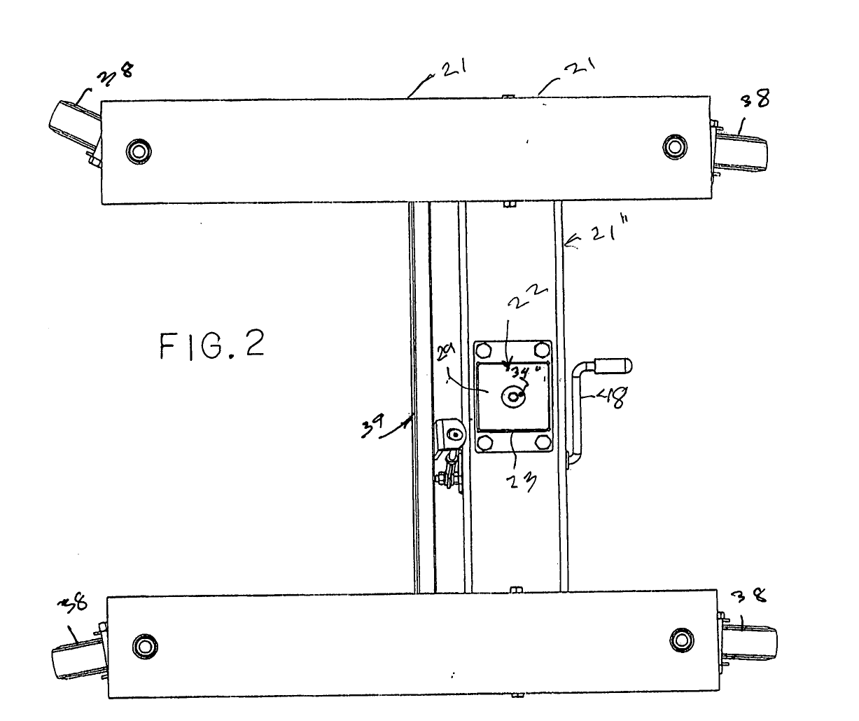

FIG. 2 is a cross sectional view taken along line 2-2 of FIG. 1.

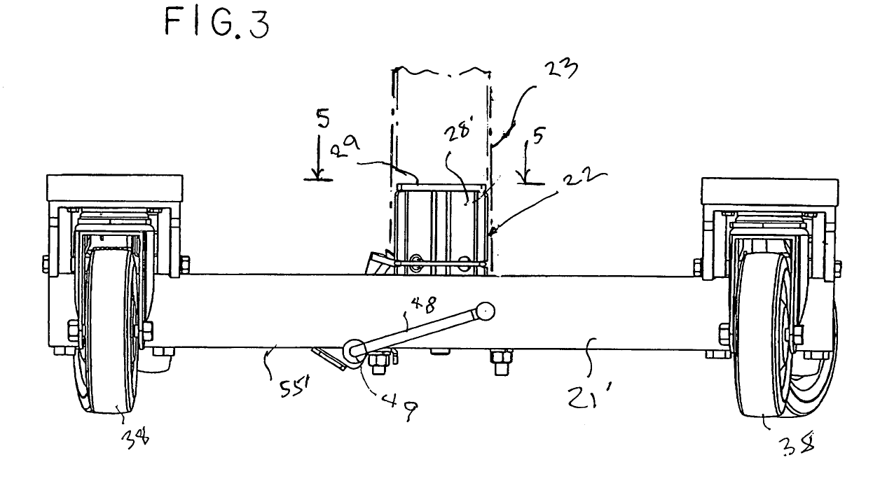

FIG. 3 is a fragmentary front elevational view of the base of the cabinet lift.

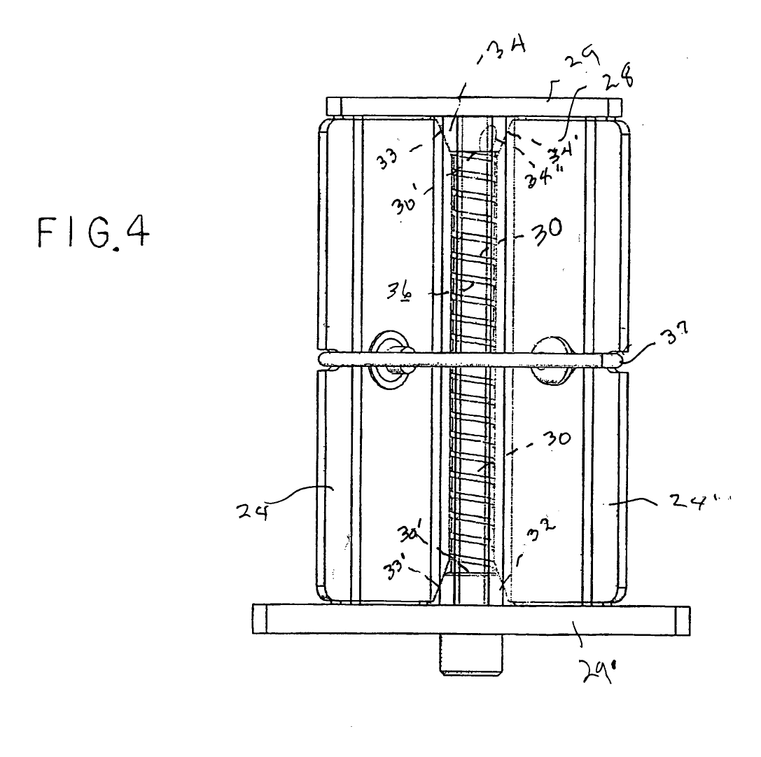

FIG. 4 is an enlarged side elevational view of the adjustable post mechanism.

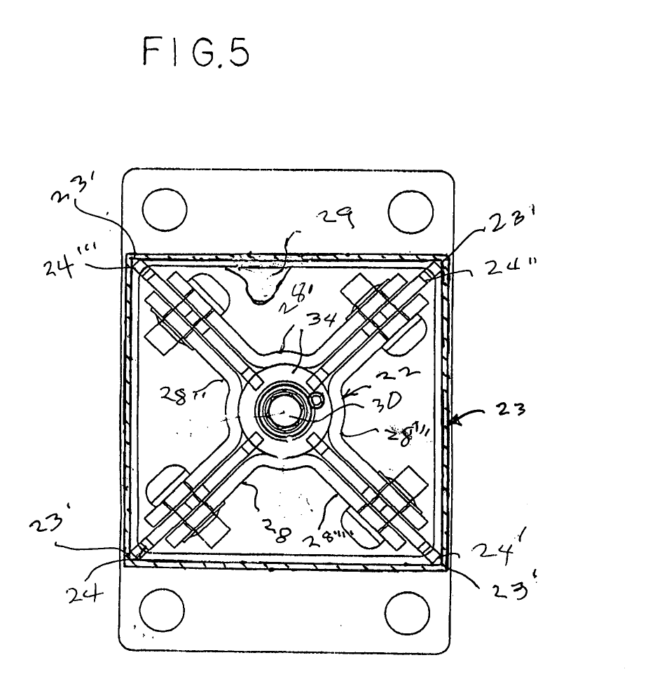

FIG. 5 is an enlarged top view of the adjustable post mechanism taken along line 5-5 of FIG. 3.

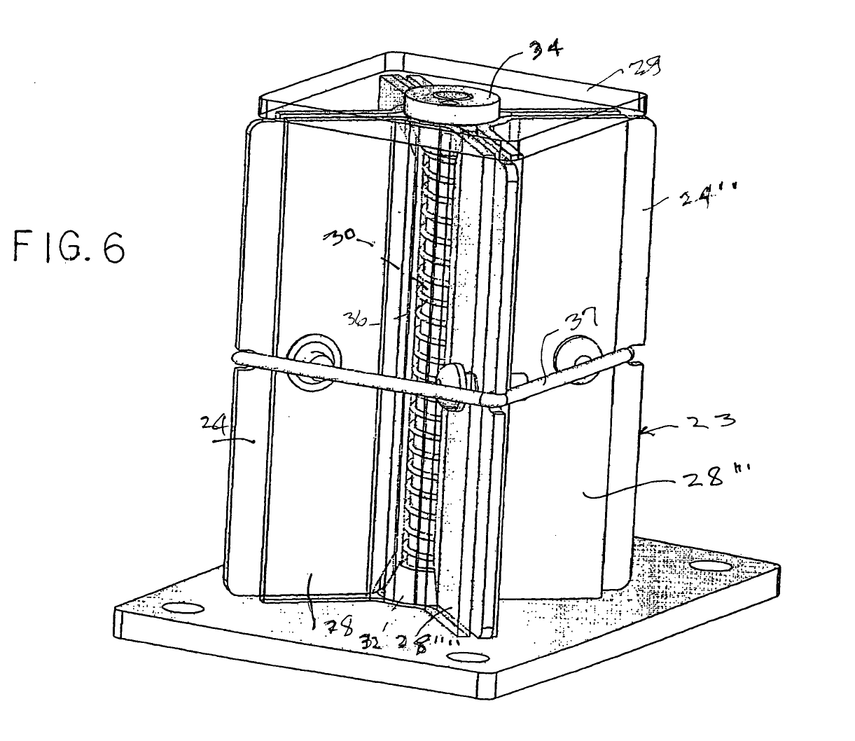

FIG. 6 is a perspective view of the adjustable post mechanism.

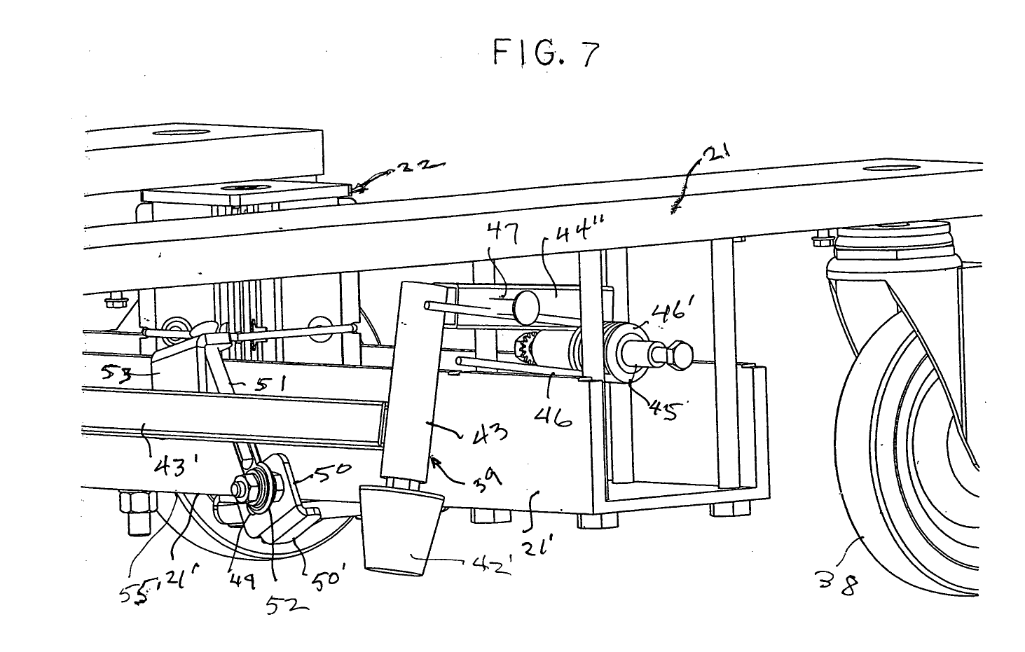

FIG. 7 is a perspective view of the base, adjustable post and brake mechanism.

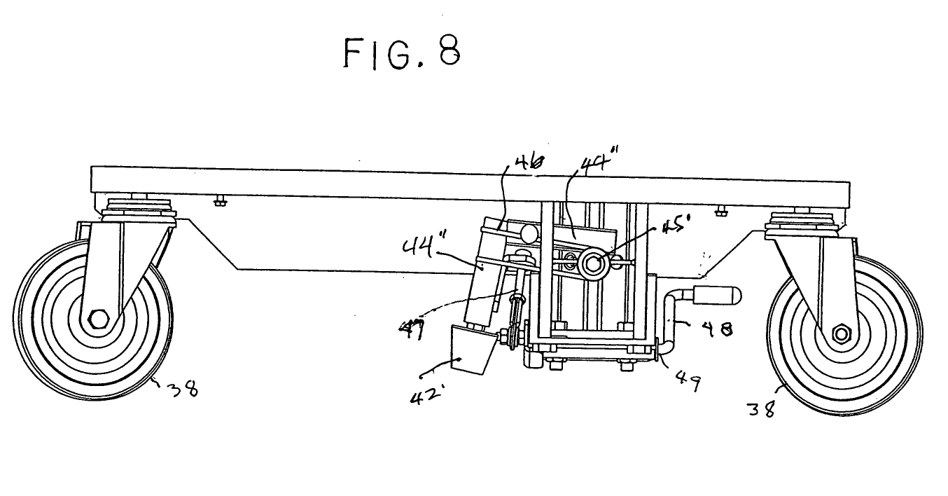

FIG. 8 is a side elevational view of the adjustable post mechanism showing a side view of the brake mechanism and means to raise and lower the brake mechanism to engage the floor for locking the base from movement.

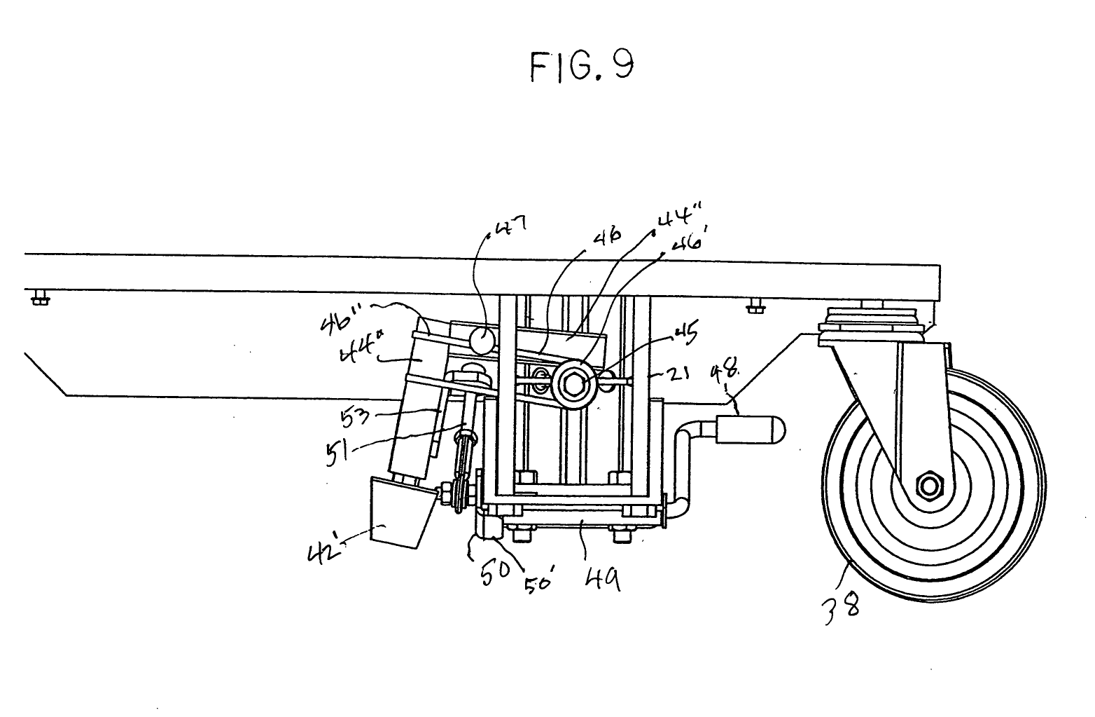

FIG. 9 is an enlarged side elevational view of the base.

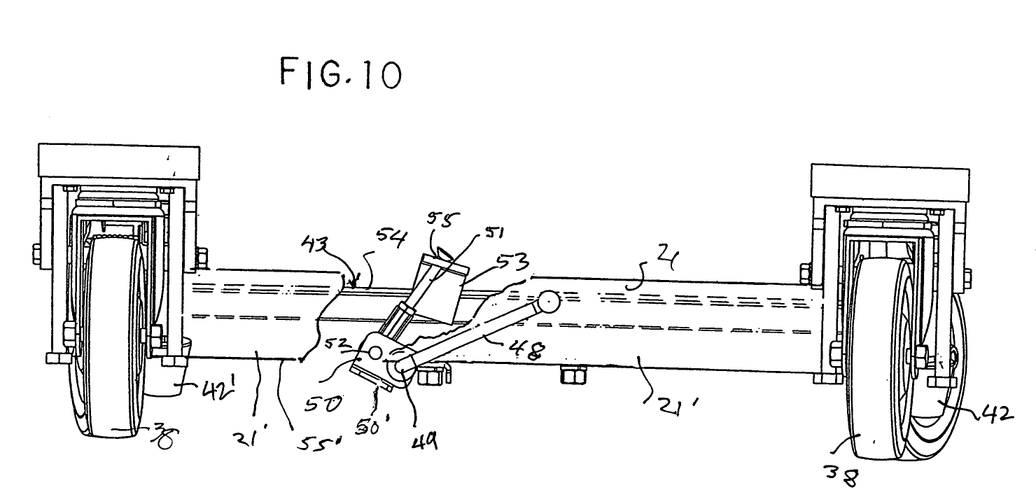

FIG. 10 is front elevational view of the base illustrating the brake mechanism in its lowered engaged position.

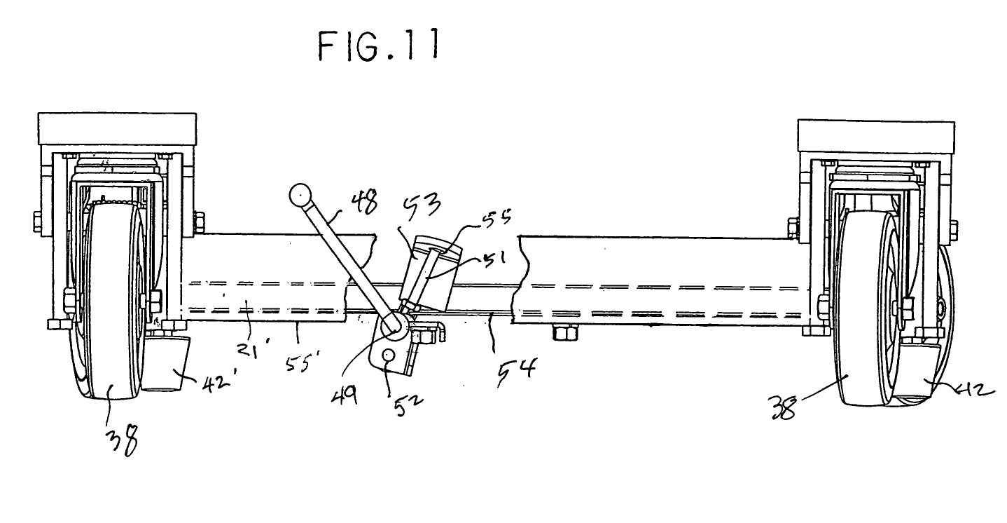

FIG. 11 is a front elevational view of the base illustrating the brake mechanism in its raised and disengaged position.

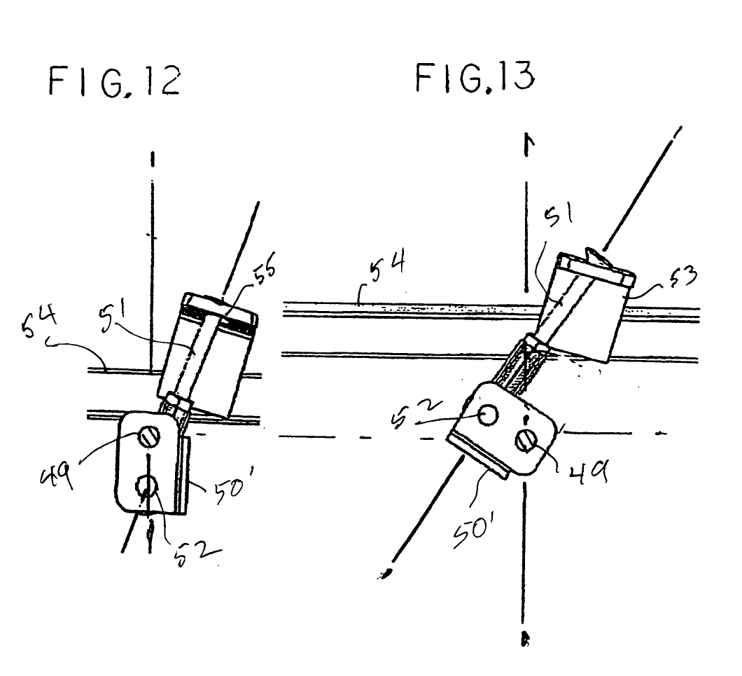

FIG. 12 is a fragmentary enlarged view of the lever portion of the brake mechanism in its lower engaged position

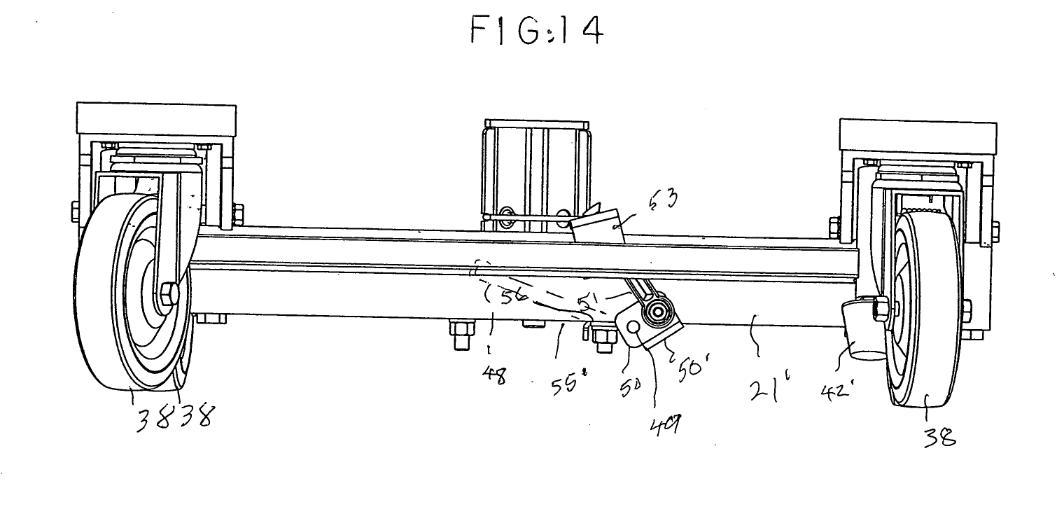

FIG. 13 is a fragmentary enlarged view of the lever portion of the brake mechanism in its raised position

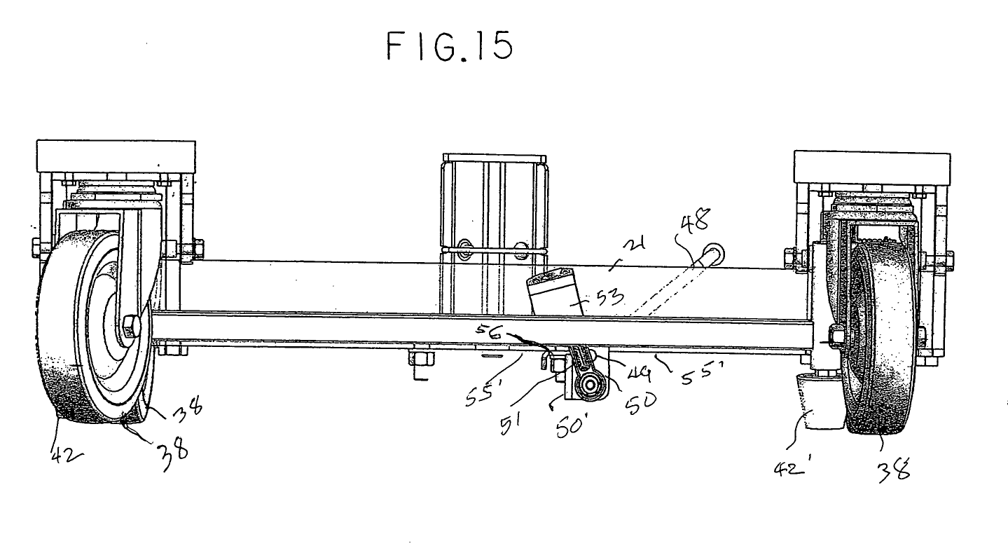

FIG. 14 is a rear elevational view of the base illustrating the lever portion of the brake mechanism in its raised and disengaged position.

FIG. 15 is a rear elevational view of the base illustrating the lever portion of the brake mechanism in its lowered engaged position with the brake pads engaging the floor.

Referring more particularly to the drawings, the improved cabinet lift invention 20 is illustrated in FIG. 1 for use by craftsmen in installing cabinets in kitchens and the like some of which may be spaced above the floor. The cabinet lift invention 20 is provided with a base 21. The current invention 20 provides an improved adjustable post mechanism 22 mounted on the horizontal lateral plate 21′ of the base 21 for receiving a square vertical, tubular metal beam 23. The adjustable post mechanism 22 is slidably received internally in the bottom of the tubular metal beam 23 and is provided with four adjustable plates 24-24′″ engaging the four inner corners 23′ of the square beam 23. A vertically adjustable platform 25 has a horizontally plate 25′ thereon which extends horizontally to support objects thereon and is mounted on a collar 25″. The collar 25″ slides vertical on the beam 23. The winch pulley 26 is fixed to the collar 25″ and has a belt 27 which extends over the top 23′ of the tubular metal beam 23 and down on the other side of the tubular metal beam where it is attached to the collar 25″ of the vertically adjustable platform 25. As a result rotating the winch pulley 26 draws the belt 27 onto the winch pulley 26 and thereby raises and lowers the vertically adjustable platform 25 on the beam 23.

In greater detail, the improved adjustable post mechanism 22 having the four adjustable plates 24-24′″ and has a frame 28 with four fixed V-shaped plates 28′-28″″ fixed between upper and lower plates between 29 and 29′ to slidably support the four adjustable plates 24-24′″ so that they may move or slide radially inward and outward on the V-shaped plates 28′-28″″ of the frame. The frame has an elongated screw 30 in the center of the four radially extending adjustable plates 24-24′″ The screw 30 has a lower nut 32 and an upper nut 34. The lower nut 32 has an annular adjacent to the lower tapered four central inner edges 33 of the plates to engage said lower tapered inner edges of the plates as the screw 30 is not threaded adjacent the lower nut 32.

The upper nut 34 is threaded onto the upper end of the screw 30 and has a pin 34″ projecting outward and downwardly from the upper nut 34 so as to engage one of the four adjustable plates 24-24′″ depending upon its position, so as to allow only limited movement of the nut relative to the screw to approximately the 45 degree space between the plate thereby effectively fixing the upper nut relative to the screw 30. The upper nut 34 has tapered annular surfaces 34′ which opposes the tapered annular surfaces 32′ at the lower end of the lower nut 32 so that the tapered upper and lower surfaces34′ and 32′ of the upper and lower nuts can simultaneously can engage the tapered upper and lower surfaces 33 and 33′ surfaces of the plates, if the lower nut is drawn toward the upper nut 34.

The threading of the screw 30 into the upper nut 34 acts to draw the upper nut 34 downward towards the lower nut 32. Simultaneously this action draws the lower nut 32 upward while moving the screw 30 upward in the threading action. A coil spring 36 is mounted coaxially on the screw 30 and acts to engage the very nose 30′ of the nuts, adjacent the upper and lower cam surfaces of upper and lower nuts; so that, though turning or threading the lower nut toward the upper nut will act to raise the screw toward the upper cam surfaces 34′, thereby bringing the upper and lower cam surfaces of the nuts 32 and 34 toward one another, the coil spring pressure of spring 36 will act to keep the nuts apart so as to prevent free movement of the lower nut except by deliberate manual action by the operator threading the nuts together.

The tapered lower surfaces of the lower annular nut and the tapered annular surfaces 34′ of the upper nut 34 acts to simultaneously engage the upper and lower tapered four surfaces 33 and 33′ upper nut 34 acts to simultaneously engage the upper and lower tapered four surfaces 33 and 33′ of the plates to cam the upper and lower edges outward to slide the four plates outward, when the screw is turned to thread or draw the nut 34 toward the upper end of the screw 30. The outward camming causes the plates to slide outward and engage in the four inner corners 23′ of the beam 23 to lock the frame 28 to the beam 23 for the engagement process or operation.

Conversely turning the screw 30 in the opposite direction lowers or lengthens the screw relative to the bolt and thereby allows the four plates to freely separate and move radially inward from the four corners of the post to release the post mechanism from the beam.

A tension spring 37 surrounds the exterior of the four adjustable plates urging them inwardly towards one another so that when the screw 30 is rotated to cause the cam surfaces of the nuts to move away from one another, the tension spring 37 will urge the plates toward one another following the contour of the cams. Thereby the cams, tension spring, and coil spring, in cooperation with one another act to adjust the adjustable plates 24-24′″ radially inward and outward into the four internal corners 23′ of the square beam 23 with the adjustable post mechanism 22 being adjustable by the screw 29 which may be turned by a conventional Allen wrench.

By moving the four adjustable plates 24-24′″ outward by means of the screw 30 being turned by the Allen wrench, the plates can fit tightly into the four inner corners 23′ of the beam 23 to provide a solid connection so that the beam 23 will not teeter on the adjustable post mechanism 22. Yet by turning the screw 30 in the opposite direction the four adjustable plates 24-24′″ can be retracted towards one another to enable the beam to be freely removed from the adjustable post mechanism 22.

lower nuts 34 and 32 simultaneous and evenly engaging the upper and lower tapered inner edges of the plates outward, it causes the plates to move outward with the upper and lower outer edges of the plates evenly and in equal strength for the entire height of the outer edges engage the inner corners of the beam in flush relation.

The base 21 is also provided with four caster wheels 38 for rotatively supporting the base.

A brake mechanism 39 for the cabinet lift invention 20, is provided to prevent the base 21 of the lift invention from moving while the lift is in operation. The brake mechanism 39 has a lateral downwardly extending gripping members 42 and 42′.

A U-shaped brake 43 has an elongated center piece 43′ with parallel lateral outer ends 44′ and 44″ is pivotally mounted to the base 21 at its outer ends 44′ and 44″. The lateral outer ends 44′ and 44″ of the U-shaped member 43 are pivotally mounted on a pair of stub shafts 45. Downward extending gripping members or brake pads 42 and 42′ are fixed to the other end portion of the outer ends 44′ and 44″. A coil spring 46 is mounted on one of the stub shafts 45 and encircling the stub shaft with its one end 46′. The one end 46′ is a non rotatable relation to one stub shaft 45 and extends outwardly with its other end 46″ engaging pin 47 as shown in FIG. 9. The pin 47 is mounted to the parallel lateral outer end 44′ at a location spaced away from the stub shafts 45 so that it urges the U-shaped brake 43 upward about their stub shafts 45.

A handle 48 has a shaft 49 which is pivotally mounted to the horizontal beam 21′ of the base 21 to pivot on the beam about an axis of shaft 49. The shaft 49 has a lateral plate 50 fixed laterally to the shaft 49. An adjustable screw 51 has one end pivotally mounted to the lateral plate 50 at pivot point 52. A projecting flange 53 is fixed to the cross brace 54 of the U-shaped brake 43. The adjustable screw 51 at its other end is mounted in an aperture 55 of the projecting flange plate 53 to move freely in the aperture An adjustable screw 51 has one end pivotally mounted to the lateral plate 50 at pivot point 52. A projecting flange 53 is fixed to the cross brace 54 of the U-shaped brake 43. The adjustable screw 51 at its other end is mounted in an aperture 55 of the projecting flange plate 53 to move freely in the aperture 55.

The rotation of handle 48 in a counter clockwise direction when viewed from FIG. 10 acts to lower the brake pads to the floor 40 and the rotation of the handle clockwise when viewed from FIG. 11 acts to raise the brake mechanism off the floor 40. In more detail the counter clockwise rotation of the handle 48 rotates the shaft 49 about its axis counter clockwise when viewed from FIG. 10. This in turn rotates the lateral plate 50 counter clockwise downward, which rotates one end of the adjustable screw 51 downward counter clockwise from its position shown in FIG. 10 and 13. The movement of the adjustable screw 51 downward draws the projecting flange 53 downward. This in turn draws the U shaped brake 43 downward to move the brake pads 42 and 42′ on the U shaped brake downward until they engage the floor.

The movement of the handle 48 counterclockwise from its position shown in FIGS. 10 and 13 (clockwise when viewed from FIGS. 14 and 15) to its position shown in FIGS. 11 and 12 moves the lateral plate 50 counterclockwise past center causing the lateral flange 50′ of the plate 50 to engage a plate 56, which plate is fixed to the bottom wall portion 55′of the lateral beam 21′. This engagement prevents the spring 46 from drawing the flange 53 further counterclockwise back upward thereby effectively locking the plate 50 thereby locking the brake mechanism with the brake pads in their lower engaged position on the floor.

The rotation of the handle 48 is a clockwise direction when viewed from FIG. 11 acts to raise the brake pads 42 and 42′ from the floor 40. In more detail, the clockwise rotation of the handle 48 rotates the shaft 49 about its axis clockwise. This in turn rotates the lateral plate 50 clockwise upward, which rotates one end of the adjustable screw 51 upward from its position shown in FIG. 11 and FIG. 12. The movement of the adjustable screw upward pivots and raises the U shaped brake upward to raise the brake pads 42 and 42′ on the U shape brake upward off the floor.

The movement of the handle clockwise past center unlocks the brake allowing the spring 46 to raise the U shape brake 43 upward off the ground back to its position shown in FIG. 10 and 13. Consequently, the operator by pivoting the handle 48 can pivot the shaft 49 to raise and lower the U-shaped brake 43 flush with the floor 40 to firmly engage the floor and serve as the brake.

The base 21 can be provided without caster wheels with a shorter post or square beam 23 for use in mounting upper cabinets on a wall after the floor cabinets have been installed, by placing the base on the counter of the floor cabinets, and then putting the upper cabinets on the vertically adjustable platform 25 which can be raised and lowered which sliding platform may be slidably mounted on a shorter square beam 23 of the device.

It will be obvious that various changes and departures may be made to the invention without departing from the spirit and scope thereof and accordingly it is not intended that the invention be limited to that specifically described in the specification or as illustrated in the drawings but only as set forth in the appended claims wherein:

What is claimed is:

1. A cabinet lift device having a base with a vertical tubular elongated upright beam serving as a main support, a beam support post mounted to the base, said post detachably supporting the tubular beam upright on the base, said post having four radically adjustable plates, cam means for adjusting said plates radially inwardly and outwardly on the base, said cam means comprising a screw extending upward through said post at the center of said adjustable plates, a screw at the upper end of said post, said screw having cam means at its lower end and said nut having cam means at its upper end, said plates having taper surfaces to react with said cam means, said screw being threadable in said nut to draw said cam means on said screw toward said cam means on said nut to cause said cam mean to engage the tapered surfaces on said plates to simultaneously to cam the plates outward in said beam, said beam being receivable over said adjustable plates and having inner corners, whereby adjusting the cam mechanism will act to cam the plates outwardly to engage the inner corners of the beam to rigidly secure said post to said beam, said screw being operable by rotation of an Allen wrench, said adjustable plates of said post enabling beams to be used as a lift having differing inner diameters by said plates adjusting to said different diameters.

2. A cabinet lift device comprising a base, said base having a support post mounted centrally thereon, a tubular beam serving as a support; said beam having interior surfaces, said beam being mounted detachably to said post, said post having a plurality of radially adjustable plates adjustable outwardly to engage the interior surfaces of said hollow beam, pulley means mounted to the beam at its upper end whereby said beam may be mounted onto said post with said radially adjustable plates being adjustable firmly against the interior surfaces of said hollow beam with said adjustment enabling beams to be employed having inner diameters with various tolerances, said device having detachable pulley means for detachably mounted to said beam at its upper end whereby said beam may be mounted to said post and said pulley may be mounted to said beam and said pulley may be used as a cabinet lift.

3. A beam support comprising a base, said base having an upright post, said beam being detachably mounted to said post, said beam being hollow and having interior surfaces, said post having a plurality of radially adjustable plates, said plates being adjustable radially outward against the interior surfaces of said hollow beam to secure said beam immobile to said post with said adjustable plates adjusting radially for securing said beam to said post with a high degree of immobility.
